(19) United States
(12) Patent Application Publication
(10) Pub. No.: US 2024/0301726 A1
(43) Pub. Date: Sep. 12, 2024

(54) Automated Dump Truck Tailgate Control

(71) Applicant: Intellectual Property Group, LLC, Raleigh, NC (US)

(72) Inventor: James Patrick Godwin, Jr., Dunn, NC (US)

(21) Appl. No.: 18/119,930

(22) Filed: Mar. 10, 2023

(51) Int. Cl. E05B 77/54; B60P 1/26; B60Q 5/00; B60Q 9/00; E05B 81/56

(52) U.S. Cl. CPC E05B 77/54; B60P 1/26; B60Q 5/005; B60Q 9/00; E05B 81/56

(57) ABSTRACT

A computerized controller ensures that the tailgate of a dump truck is in a closed position, latches the tailgate to the truck bed, and locks the tailgate closed when a speed of the dump truck is at or above a selected predetermined speed. The system implements two complementary functions: Tailgate Latch and Lock (TLL) and Tailgate Closed Assurance (TCA). The TLL function monitors the dump truck speed, and automatically latches the tailgate when the dump truck exceeds a selected predetermined speed. The TLL function will not release the tailgate latch until the dump truck is moving below the selected predetermined speed, regardless of operator input. In implementation, the TLL function relies on TCA. The TCA function ensures that the tailgate is in a fully closed position prior to the TLL actuating the tailgate latch, thus eliminating the possibility of “false positive” TLL actuation if the latch is fouled with debris.

### FIELD OF INVENTION

The present invention relates generally to articulated dump trucks, and in particular to a system and method of automatically verifying the closed status of a dump truck tailgate, and automatically latching and locking the tailgate if the dump truck exceeds a selected predetermined speed.

### BACKGROUND

The global market for dump trucks in 2021 surpassed $15B, and is projected to increase to $30B by 2030, at a CAGR of over 7%. Dump trucks are used in mining, construction, waste management, snow and ice removal, and other industries. Growth in the dump truck market is driven by increased exploration in the mining industry, sustaining investment in transportation infrastructure in the construction industry, and the growth of counties and municipalities requiring snow removal equipment. Investment in new dump trucks is required to meet increasingly stringent emissions and other environmental controls, and to take advantage of technological advances.

One such technological advance is computer control of mechanical systems, which have conventionally been controlled manually. U.S. Pat. No. 11,377,805, the disclosure of which is incorporated herein by reference in its entirety, describes a computerized control system, which may be implemented in a tablet computer or other similar controller, for driving a hydraulic subsystem and other equipment, such as a sand/salt spreader. The hydraulic subsystem may, in turn, drive equipment such as the articulated bed of a dump truck, a snowplow, or the like. Similarly, pending U.S. patent application Ser. No. 17/840,197, the disclosure of which is also incorporated herein by reference in its entirety, describes a safety feature whereby a hydraulic subsystem that raises and lowers a dump truck bed is controlled to automatically lower the dump truck bed, while simultaneously activating a visual/audible alarm, if the bed is raised while the moving dump truck exceeds a predetermined speed.

The tailgate of a conventional dump truck has been known to come unlatched while the dump truck is travelling on a road or highway, releasing its load and creating a road hazard to other traffic. The latch may fail to properly secure, due to debris, ice, or the like blocking it. Alternatively, the operator may inadvertently release the latch during transit. As experienced dump truck drivers retire, the industry has experienced a shortage of qualified drivers. New drivers lack experience, and in many cases are minimally (sometimes inadequately) trained, thus learning dump truck control “on the job.” This increases the potential for error in driving conventional dump trucks, where control of the unique hydraulic subsystems place demands on drivers' attention, in addition to the rigors of safely driving a large, heavy truck.

The Background section of this document is provided to place embodiments of the present invention in technological and operational context, to assist those of skill in the art in understanding their scope and utility. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of embodiments of the invention or to delineate the scope of the invention. The sole purpose of this summary is to present some concepts disclosed herein in a simplified form as a prelude to the more detailed description that is presented later.

According to aspects of the present disclosure, a computerized control system ensures that the tailgate of a dump truck is in a fully closed position, securely latches the tailgate to the truck bed, and locks the tailgate in this position, when a speed of the dump truck is at or above a selected predetermined speed. The system implements two complementary functions: Tailgate Latch and Lock (TLL) and Tailgate Closed Assurance (TCA). The TLL function monitors the dump truck speed, and automatically latches the tailgate when the dump truck exceeds a selected predetermined speed. The TLL function will not release the tailgate latch until the dump truck is moving below the selected predetermined speed, regardless of operator input. In implementation, the TLL function relies on TCA. The TCA function ensures that the tailgate is in a fully closed position prior to the TLL actuating the tailgate latch, thus eliminating the possibility of “false positive” TLL actuation if the latch is fouled with debris. In one aspect, a “spreading mode” feature partially or fully overrides TTL, either by disabling it or by selecting a higher predetermined dump truck speed, for operations such as spreading gravel on a roadbed, where the dump truck must move with its bed raised and tailgate open. For safety, when enabled, the spread mode feature must be affirmatively selected by the dump truck driver prior to each spreading run.

One aspect relates to a method of securing a tailgate of a bed of an articulated dump truck during transit. A speed of the dump truck is sensed. Whether the tailgate is in a fully closed position is also sensed. The sensed speed of the dump truck is compared to a selected predetermined speed. When the sensed speed of the dump truck equals or exceeds the selected predetermined speed and the tailgate is in the fully closed position, one or more latches are automatically actuated to lock the tailgate in the closed position.

Another aspect relates to a controller configured to control one or more tailgate latches of a dump truck. The controller includes memory and processing circuitry operatively connected to the memory. The processing circuitry is configured to: sense a speed of the dump truck; sense whether the tailgate is in a fully closed position; compare the sensed speed of the dump truck to a selected predetermined speed; and when the sensed speed of the dump truck equals or exceeds the selected predetermined speed and the tailgate is in the fully closed position, automatically actuate the one or more latches to lock the tailgate in the closed position.

Yet another aspect relates to a dump truck. The dump truck includes a chassis, an articulated dump truck bed moveably connected to the chassis, and a dump truck bed actuating mechanism configured to raise and lower the dump truck bed. The dump truck further includes a tailgate pivotally connected to the dump truck bed, and one or more latches configured to secure the tailgate to the dump truck bed in a closed position for holding material, and to allow the tailgate to at least partially separate from the dump truck bed in an open position for discharging material when the dump truck bed is raised by the dump truck bed actuating mechanism. The dump truck additionally includes a proximity sensor configured to output an indication when the tailgate is in a fully closed position on the dump truck bed.

### BRIEF DESCRIPTION OF THE DRAWINGS

The present disclosure will now be described more fully hereinafter with reference to the accompanying drawings, in which aspects of the disclosure are shown. However, this disclosure should not be construed as limited to the aspects set forth herein. Rather, these aspects are provided so that this disclosure will be thorough and complete, and will fully convey the scope of the disclosure to those skilled in the art. Like numbers refer to like elements throughout.

FIG. 1A depicts an articulated dump truck with the bed lowered.

FIG. 1B depicts an articulated dump truck with the bed raised.

FIG. 2A depicts a tailgate of the dump truck in a partially open position.

FIG. 2B depicts the tailgate of the dump truck in a closed position.

FIG. 3 is a block diagram of a controller in a dump truck.

FIG. 4 depicts a proximity sensor and target surface or mass for detecting whether the tailgate is in the fully closed position.

FIG. 5 is a flow diagram of a method of securing a tailgate of a bed of an articulated dump truck during transit.

### DETAILED DESCRIPTION

For simplicity and illustrative purposes, the present disclosure is described by referring mainly to an exemplary aspect thereof. In the following description, numerous specific details are set forth in order to provide a thorough understanding of the present disclosure. However, it will be readily apparent to one of ordinary skill in the art that the present disclosure may be practiced without limitation to these specific details. In this description, well known methods and structures have not been described in detail so as not to unnecessarily obscure the present disclosure.

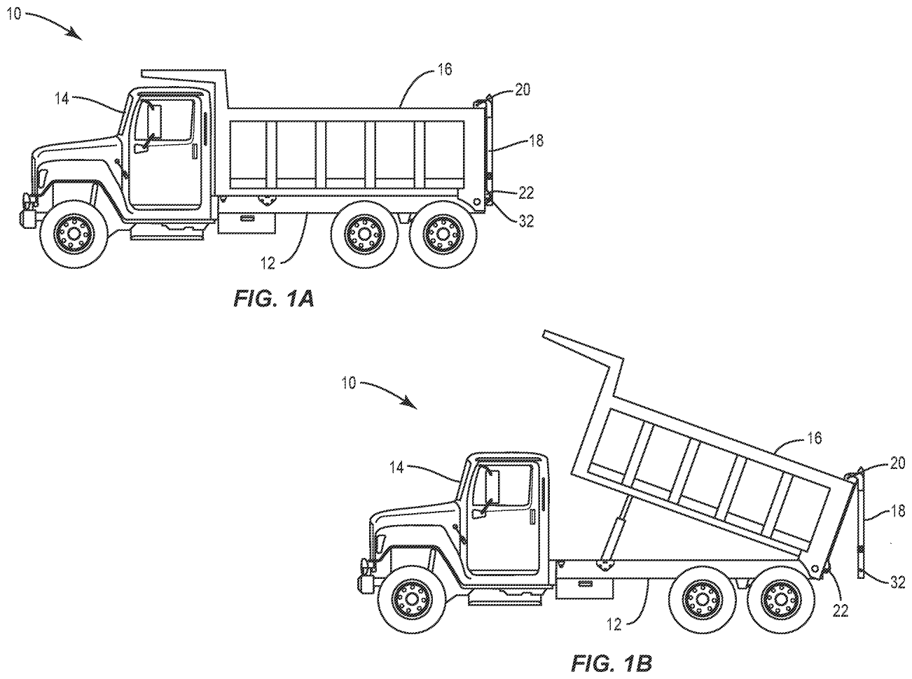

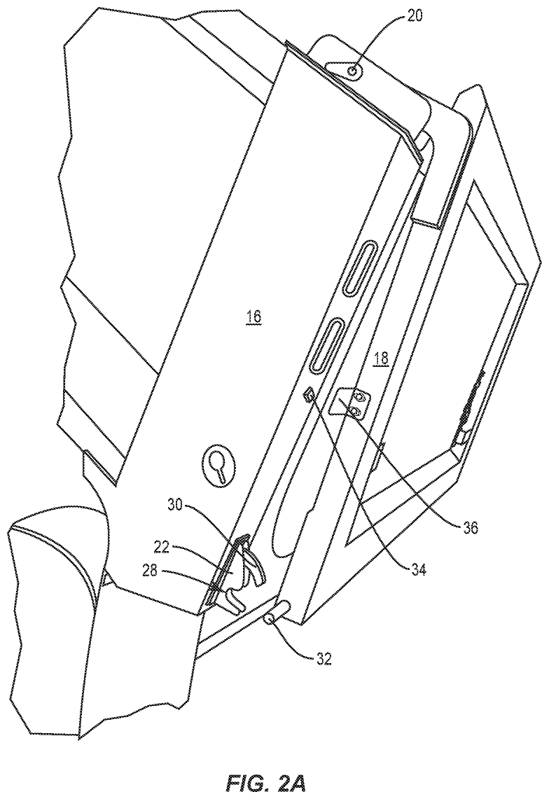

FIG. 1A depicts a dump truck 10, including a chassis 12, cab 14, and articulated dump truck bed 16 with a tailgate 18. The dump truck 10 in FIG. 1A has the bed 16 lowered, which is the configuration used to store or transport a load of material in the bed 16, such as sand, gravel, asphalt, salt, or the like. FIG. 1B depicts the dump truck 10 with the bed 16 moved to a raised position by a hydraulic actuator 26. The raised position is normally only used to discharge, or “dump,” the truck's load. As well known, the tailgate 18 of the bed 16 is the inverse of a tailgate on a pickup truck—it is hinged 20 at the top, and has latches 22 at one or both sides of the bottom to hold the tailgate 18 in the closed position. As depicted in FIG. 1B, when the dump truck bed 16 is raised, the tailgate 18 hangs freely in a generally vertical orientation, creating a space, or opening, between the tailgate 18 and the bottom of the dump truck bed 16, through which the load of gravel, sand, or the like flows.

Conventionally, the hydraulic actuator 26 is controlled manually by the truck operator (also referred to as the driver; the term operator is used herein because operation of a dump truck involves far more than simply driving it). For example, a hydraulic control module in the cab 14 includes, e.g., a lever which is moved in one direction to raise the bed 16 and the opposite direction to lower it. Also, conventionally, latches 22 that secure the tailgate 18 to the bed 16 in the closed position are either manually actuated, or (particularly in larger dump trucks 10) are pneumatically or hydraulically actuated under manual control, similar to raising and lowering the bed 16.

Manual operation of both the hydraulic actuator 26 and latches 22 enables certain hazardous conditions and modes of operation that should be avoided. The above-incorporated patent application Ser. No. 17/840,197 describes a system and method of eliminating the risk of a raised dump truck bed 16 striking bridges, power lines, and the like, by forcing automated lowering of the bed 16 when it is sensed that the dump truck 10 is in motion. Similarly, manual control of the tailgate latches 22 can present safety hazards. For example, in at least one known case, an operator using manual controls inadvertently disengaged the latches 22 during transport of a load of crushed stone on a freeway, allowing the tailgate 18 to swing partially open, and dispensing stone and gravel on the roadway at a highway speeds.

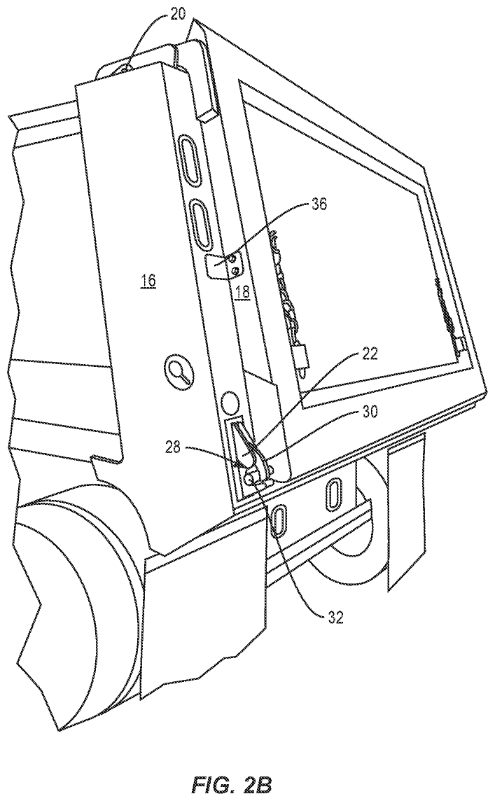

Tailgates 18 on conventional dump trucks 10 can improperly open during transit even without improper operator input, such as by failure to fully seat upon closing. FIG. 2A shows a tailgate 18 latched in the closed position, and FIG. 2B shows the tailgate 18 unlatched and in a partially open position. Operation of the latch 22 is straightforward. The latch 22, typically mounted on the dump truck bed 16, includes a recess 28 sized and shaped to receive a protruding post 32 on the tailgate 18. When the post 32 is seated in the recess 28, a latching arm 30 moves from an open position, in which it is clear of the recess 28, to a closed position in which it covers the seated post 32, preventing it from escaping the recess 28. This locks the tailgate 18 to the dump truck 16 in a fully closed position. However, the latch 22 may fail if the post 32 fails to fully seat within the recess 28 prior to actuation of the latching arm 30, which may occur if the recess 28 is partially clogged.

Some loads, such as asphalt, have temperature-dependent viscosity. The asphalt is loaded hot and flows easily. As the asphalt cools, however, such as while waiting in a line of dump trucks at a paving site, the viscosity increases, and the asphalt becomes prone to sticking to various parts of the dump truck bed 16. In some cases, asphalt can lodge within the recesses 28 of one or both latches 22, preventing the corresponding post(s) 32 from properly seating. Ice forming on the latch 22 in freezing weather, or other loads and/or conditions, may result in the same interference. In such cases, when the latching arm 30 then actuates, it may only partially grasp the post 32. The latches 22 then appear to be closed and the tailgate 18 locked in the closed position. However, a jar, such as caused by the dump truck 10 hitting a pothole during transit, can knock the post 32 free, allowing the tailgate 18 to swing partially open, releasing the load and creating a road hazard.

Aspects of the present disclosure prevent inadvertent opening of a dump truck 10 tailgate 18 during transit—whether by inadvertent (or intentional) control input by the operator, or due to improper operation of the latch 22, such as from fouling by debris.

According to aspects of the present disclosure, a computerized control system ensures that the tailgate 18 of a dump truck 10 is actually closed, and securely latched, during movement of the dump truck 10 above a selected predetermined speed. The system locks the tailgate 18 closed by maintaining the latches 22 in the closed state, disregarding any input to the contrary by the operator. The system implements two complementary functions: Tailgate Latch and Lock (TLL) and Tailgate Closed Assurance (TCA). TLL will be described first under the nominal assumption that the tailgate latches 22 are clear and operate properly, and that the dump truck 10 is used only for transport and dumping of a load.

### TLL/TCA System

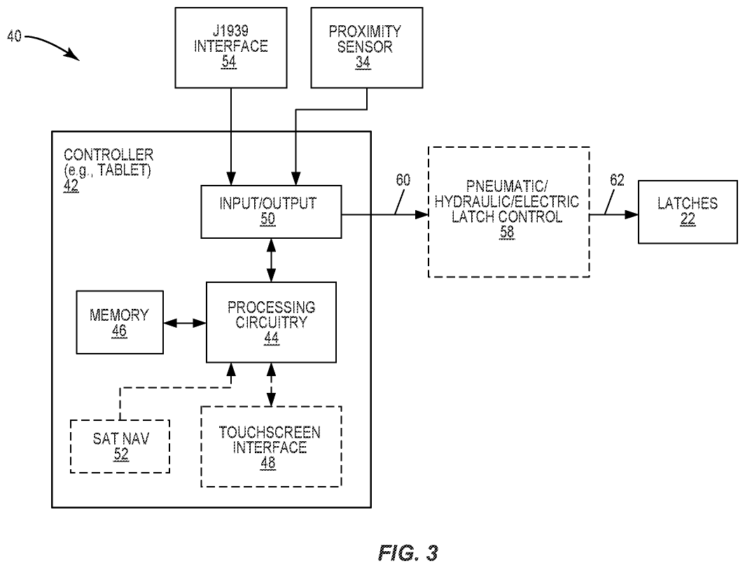

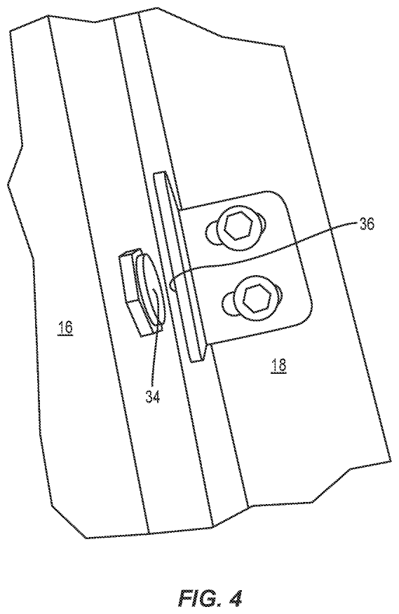

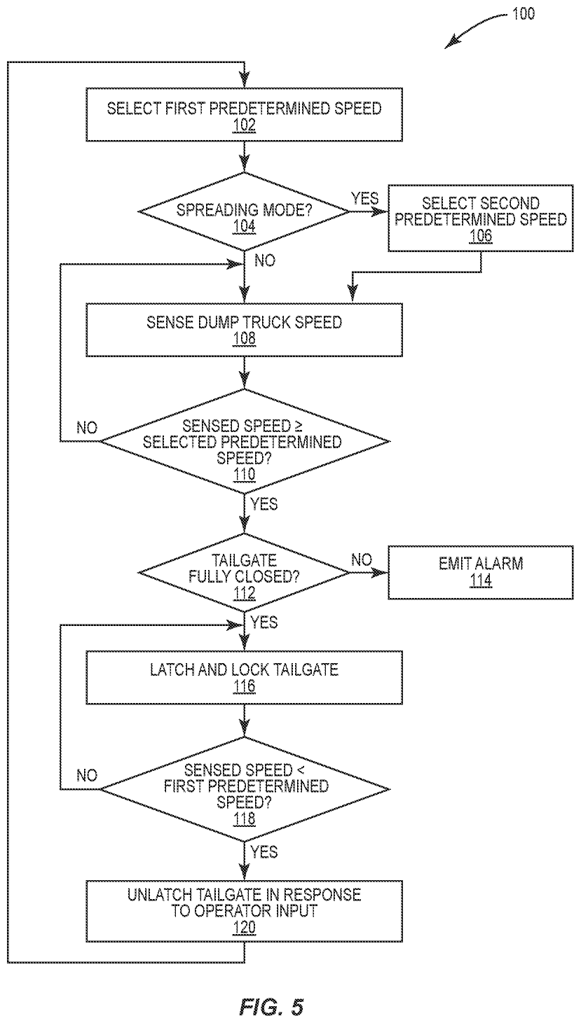

FIG. 3 shows a functional block diagram of the TLL/TCA system 40. The core of the system 40 is a programmable controller 42. The above-incorporated references describe one aspect of a controller 42, for example a touchscreen-based tablet computer, mounted in the cab 14 of a dump truck 10, conveniently visible to and accessible by the dump truck 10 operator. However, aspects of the present disclosure are not limited to such an implantation, and those of skill in the art will understand that the controller 42 may be implemented in numerous ways. In any event, the controller 42 includes processing circuitry 44, memory 46, and an input/output interface 50. The controller may additionally include a touchscreen interface 48, and satellite navigation receiver circuitry 52, both of which are commonly integrated into commercially available tablet computers.

The processing circuitry 44 may comprise a state machine implemented in dedicated circuitry or programmable logic together with appropriate firmware, or as any of numerous commercially available stored-program microprocessors or digital signal processors (DSP) together with appropriate software. Non-transitory memory 46 may comprise any known data storage technology, including solid state, magnetic, optical, or the like. The memory 46 is operatively connected to the processing circuitry 44, and may store program code implementing the TLL and TCA functions, as well as operating system software for the controller 42. The input/output interface 50 receives input from various eternal components or systems, and provides relevant data to the processing circuitry. The input/output interface 50 additionally generates output signals to control the latches 22, in response to commands from the processing circuitry 44.

Both the optional touchscreen interface 48 and satellite navigation receiver circuitry 52 are well known in the art, and typically integrated into tablet computers and other electronic devices. Accordingly, these circuits are not described herein in great detail. Briefly, a touchscreen interface allows software to display information and messages to the dump truck 10 operator, and to capture targeted input via the use of “soft” input features, such as buttons, sliders, and the like. Satellite navigation receiver circuitry 52 calculates geographical position from signals received from satellites, and reports updated position data to the processing circuitry 44 at regular intervals, such as 1 Hz. The instantaneous speed of the dump truck 10 can easily be determined from this periodic position data.

In addition to the optional satellite navigation receiver circuitry 52, the processing circuitry 44 receives periodic updates reporting the instantaneous speed of the dump truck 10 from an on-board diagnostics system integrated into the dump truck 10, such as the Society of Automotive Engineers' standard SAE J1939. J1939 is a high-level protocol based on the Controller Area Network (CAN) bus, commonly used in vehicles for the dissemination and collection data between Electronic Control Units (ECU) in most modern vehicles. J1939 is optimized to the data networking needs of heavy equipment and vehicles deploying diesel engines.

### Tailgate Latch and Lock

The TLL function monitors the dump truck 10 speed, and automatically actuates the tailgate latches 22 to lock the tailgate 18 in the closed position when the dump truck 10 reaches or exceeds a first predetermined speed. The TLL function will not release the tailgate latch 22 until the dump truck 10 is moving below the first predetermined speed. For the entire duration that the dump truck 10 is moving at or above the first predetermined speed, the controller 42 disregards any operator input to release the latches 22. The first predetermined speed is high enough to permit maneuvering of the dump truck 10 at a mining or construction site, but is lower than the dump truck 10 would be operated on public roadways. In one aspect, the first predetermined speed is in the range of 5-10 mph. Accordingly, the TLL function automatically prevents opening of the tailgate 18 while the dump truck 10 is in transit on public highways, with no provision for manual override.

In one aspect, the controller 42 (via the input/output interface 50) directly controls actuation of the latches 22. For example, the latches 22 may be controlled (individually or in tandem) by a solenoid, electric motor, or the like. In this aspect, the controller 42 provides the appropriate electrical signals to effect actuation and release of the latches 22 (or control signals to activate relays which switch vehicle power to do so). In this aspect, the output signals 60 and 62 are electrical signals, which are connected in the absence of the block 58.

In another aspect, which may be prevalent on larger dump trucks 10, physical actuation of the latches 22 is performed by a pneumatic, hydraulic, electrical, etc., latch control subsystem 58, under the control of control signals 60 output by the controller 42. For example, the control signal 60 may control a pneumatic valve (not shown), which controls the provision or release of pneumatic fluid to or from a pneumatic cylinder (not shown), which rotates a shaft (not shown) linking and physically actuating the latches 22. In this case, the line 62 comprises a pneumatic fluid conduit. In another aspect, the latch control subsystem 58 may be part of, or otherwise utilize hydraulic fluid from, the dump truck bed actuator 26, in which case the line 62 comprises a hydraulic fluid conduit. Those of skill in the art will recognize that the controller 42 output 60 may be tailored to effect control of the latches 22 as described herein, regardless of the implementation of the latches 22, and their physical actuation, on any given dump truck 10.

When the dump truck 10 arrives at its destination and is prepared to dump its load, and when it is stationary or moving below the first predetermined speed, the TLL function releases its lock on release actuation of the latches 22, but does not automatically release the latches 22. Rather, the controller 42 will now accept and act upon input from the dump truck 10 operator to release the latches 22, which input was disregarded while the dump truck 10 was in motion at or above the first predetermined speed. Operator input to release the latches 22 may, for example, comprise actuating a soft button displayed on the touchscreen of the controller 42.

### Tailgate Closed Assurance

For simplicity and ease of explanation, the above description assumed a clean dump truck 10, in which the latches 22 are clear and always properly grasp and hold the tailgate 18 in the closed position when actuated. As described above, this is not always the case. Referring again to FIGS. 2A and 2B, when asphalt, ice, or other debris collects on the latch 22, and in particular in the recess 28, the post 32 on the tailgate 18 may not fully seat within the recess 28 when the tailgate 18 is closed. Accordingly, when the latching arm 30 is actuated, it may not fully enclose, and hence may not safely contain, the post 32. In the dark, in foul weather, or in the presence of mud, asphalt, and other debris, a visual inspection of the latch 22 may not reveal the failure of the tailgate 18 to have assumed the completely closed position prior to actuation of the latch 22.

According to aspects of the present disclosure, a TCA function ensures that the tailgate 18 is fully closed prior to actuation of the latches 22. FIG. 4 depicts a proximity sensor 34 mounted to the rear face of the dump truck bed 16. A corresponding target surface or mass 36 is mounted to the tailgate 18, aligned with the proximity sensor 34 and at a predetermined distance from the proximity sensor 34 when the tailgate 18 is fully closed. The position of the target surface or mass 36 is adjusted, and the proximity sensor 34 is calibrated, such that the proximity sensor 34 outputs an indication that the tailgate 18 is closed only when the target surface or mass 36 is within a predefined distance of the proximity sensor 34. When the tailgate 18 is even partially open, the distance between the proximity sensor 34 and the target surface or mass 36 is too great for the proximity sensor 34 to generate the output. Alternatively, the proximity sensor 34 may continuously output a calculated distance to the target surface or mass 36, and the controller 42 determines from this reported distance when the tailgate 18 is in the fully closed position.

According to one aspect, the proximity sensor 34 comprises an ultrasonic transceiver. A transmitter in the proximity sensor 34 emits a pulse of sound in the ultrasonic frequency range, above the range of human hearing (i.e., greater than 20 kHz). When the tailgate 18 is fully closed, the ultrasonic sound pulse is reflected by the target surface 36, and the reflection is received by a receiver in the proximity sensor 34. By measuring the time from transmission to reflection, also known as the “time of flight” (ToF), the distance between the proximity sensor 34 and the target surface or mass 36 can be precisely measured. In one aspect, the proximity sensor 34 is calibrated to output an indication when the calculated distance indicates the tailgate 18 is in the fully closed position. If the tailgate 18 is partially open, the greater distance between the proximity sensor 34 and the target surface or mass 36 is detected, and the proximity sensor 34 does not output the “tailgate closed” indication.

Those of skill in the art will readily recognize that other ToF proximity sensors 34 may be advantageously employed within the scope of the present disclosure. For example, the proximity sensor 34 may emit and detect pulses of Radio Frequency (RF) electromagnetic energy, also known as RADAR. As another example, the proximity sensor 34 may emit and detect pulses of Infrared (IR) light. As still another example, the proximity sensor 34 may emit and detect laser pulses, also known as LIDAR. Design, implementation, and calibration of any of these ToF ranging technologies is well within the level of skill of those of ordinary skill in the art, given the teachings of the present disclosure.

ToF is not the only proximity sensing technology that may be advantageously employed in aspects of the present disclosure. For example, the proximity sensor 34 may comprise an inductive sensor. Such a proximity sensor 34 generates a high frequency magnetic field by passing high frequency current through a transmitting coil of wire. A sensing coil detects the magnetic field. The presence of a metal object distorts the magnetic field, which distortion is proportional to the size of the metal object and its distance from the coil. The sensing coil detects this distortion, and the proximity sensor 34 is calibrated to output an indication that the tailgate 18 is in the fully closed position when the target metal mass 36 is within a predetermined distance of the proximity sensor 34.

Still other sensing technologies may be advantageously employed within the broad scope of the present disclosure. For example, the proximity sensor 34 may comprise an electrical switch that closes when the target mass 36 is within a predetermined distance. In one aspect, the proximity sensor 34 is a limit switch, which closes when the target mass 36 physically touches the switch and actuates it. In another aspect, the proximity sensor 34 is a reed switch and the target mass 36 is magnetic, such as by attaching a rare earth magnet to the target mass 36. When the reed switch is within a sufficiently strong portion of the magnetic field of the target mass 36, it closes, providing an indication that the tailgate 18 is in the fully closed position. Alternatively, the switch may comprise a Hall effect switch, which also closes only in the presence of a sufficiently strong magnetic field. Those of skill in the art will readily recognize that any short-range proximity sensing technology may advantageously be utilized to verify closure of the tailgate 18 of a dump truck 10.

Regardless of the underlying technology of the proximity sensor 34, in one aspect it outputs an indication to the controller 42 only when the target surface or mass 36 is within its calibrated, predetermined range, which only occurs when the tailgate 18 is in the fully closed position, with the post 32 firmly seated within the latch recess 28. According to aspects of the present disclosure, the controller 42 uses this TCA function to ensure the efficacy of the TLL function. That is, the controller 42 only locks the latches 22, when the speed of the dump truck 10 exceeds the first predetermined speed, if an output of the proximity sensor 34 first verifies that the tailgate 18 is fully closed. If the dump truck 10 begins to move, and the proximity sensor 34 fails to provide an indication that the tailgate 18 is fully closed, when the dump truck 10 reaches the first predetermined speed, rather than actuate and lock the latches 22, the controller 42 issues an audible alarm, and displays a warning message to the dump truck 10 operator, such as via the touchscreen display. In some aspects, if the dump truck 10 continues to move above the first predetermined speed with the tailgate 18 not fully closed, the controller 42 may take additional action, such as send a wireless alert to a fleet dispatcher, or shut down the dump truck 10 engine.

In this manner, the TLL and TCA functions operate together to ensure that the tailgate 18 of the dump truck 10 is fully closed, and is latched and locked in the closed position, whenever the dump truck 10 is in transit. Note that this TLL/TCA safety feature may operate in tandem with other safety features, such as automatically lowering the dump truck bed 16 when the dump truck 10 is in motion, as described in the above-incorporated patent application.

### Spreading Mode

The typical usage of a dump truck 10 is to transport a load (sand, gravel, salt, etc.) to a destination and, as its name implies, dump the load. Aspects of the present disclosure improve safety during transit, by ensuring that the tailgate 18 of the dump truck 10 is securely latched and locked when the dump truck 10 is in motion at any appreciable speed, as defined by the first predetermined speed being fairly low. However, in addition to transport, dump trucks 10 are also sometimes used to “spread,” rather than dump, their load. For example, a dump truck 10 may spread gravel along a roadbed. In spreading operations, the tailgate 18 is unlatched, the dump truck bed 16 is partially raised, and the dump truck 10 is driven along the roadbed, as the load (e.g., gravel) spills out. In this manner, the load is spread as it is dumped, which reduces or eliminates the need for a separate spreading operation, which would require additional equipment such as a bulldozer. In a spreading operation, the dump truck 10 may be driven, with the tailgate 18 unlatched, at speeds in excess of the first predetermined speed, which would trigger the TLL/TCA warnings described above. Accordingly, in one aspect of the present disclosure, a “spreading mode” modification of the TLL/TCA functions facilitates spreading operations.

In one aspect, spreading mode simply disables the TLL/TCA functionality. In another aspect, the spreading mode is defined by the value of the predetermined speed, at or above which the TLL/TCA functions automatically latch and lock the tailgate 18 in the closed position. In this aspect of spreading mode, the TLL/TCA functions operate as described above, but using a second predetermined speed rather than the first predetermined speed, wherein the second predetermined speed is higher than the first predetermined speed. The second predetermined speed is high enough to enable spreading operations, with the tailgate 18 unlatched, but still low enough to enforce that the tailgate 18 is latched and locked during travel on public highways. In one aspect, the second predetermined speed may be in the range of 10-15 mph.

The TLL/TCA functions default to selecting the first predetermined speed. To enter spreading mode, a dump truck 10 operator must affirmatively select spreading mode for each run, such as by actuating a “spreading” soft button displayed on the touchscreen of the controller 42. In response to the spreading input by the operator, the controller 42 selects the second predetermined speed, rather than the first predetermined speed. Accordingly, as used herein, at any given time, the TLL/TCA operates with a “selected” predetermined speed. In particular, the first predetermined speed is selected by default, and the second predetermined speed is selected for each activation of spreading mode (in response to a spreading input by the operator).

For enhanced safety, in one aspect, the controller 42 automatically exits spreading mode-hence selecting the first predetermined speed-whenever the speed of the dump truck 10 falls below the first predetermined speed. This requires the operator to affirmatively selected spreading mode prior to each spreading run. Accordingly, possibly unsafe operation on public roads at speeds below the second predetermined speed, due to the operator forgetting to exit spreading mode, is prevented.

### Method

FIG. 4 depicts the steps in a method 100 of securing a tailgate 18 of a bed 16 of an articulated dump truck 10. Initially, a first predetermined speed is selected (i.e., by default) (block 102). If the dump truck 10 operator indicates spreading mode (block 104), the second predetermined speed is selected (block 106). Otherwise (block 104), the speed of the dump truck 10 is sensed, e.g., by monitoring one or both of a satellite navigation receiver and a vehicle diagnostics network (block 108). Although depicted as a discrete step 108, those of skill in the art will recognize that the dump truck 10 speed is continuously monitored. The sensed speed is compared to the selected predetermined speed (block 110).

If the sensed speed is equal to or greater than the selected predetermined speed (block 110), the position of the tailgate 18 is verified (block 112), as indicated by the output of a proximity sensor 34. If the tailgate 18 is not fully closed (block 112), an audible alarm is emitted, and a warning communicated to the operator (block 114), such as by displaying a flashing message on the touchscreen of the controller 42. In this case, the method 100 terminates until the dump truck 10 is stopped, and it begins execution again at the beginning (block 102).

If the tailgate 18 is fully closed (block 112), the tailgate latches 22 are actuated to secure the tailgate 18 in the closed position (block 116). The method 100 remains in block 116 for the duration of travel of the dump truck 10, as indicated by the arrow looping from decision block 118 back to block 116. Upon arriving at its destination, when the speed of the dump truck 10 falls below the first predetermined speed (block 118), the locking—but not the latching—of the tailgate 18 is terminated. That is, upon input from the dump truck 10 operator (and only then), the tailgate latches 22 are actuated to release the tailgate 18 and allow it to open. The method then returns to block 102, where the first predetermined speed is selected. If the dump truck 10 was in spreading mode, this effectively terminates that mode by selecting the first predetermined speed by default. To make another spreading run, the dump truck 10 operator must again affirmatively select spreading mode.

### Configuration and Control

Use of a tablet computer as the controller 42 has numerous advantages. The touchscreen interface allows the creation of a customized, intuitive user interface, through the use of soft input features and the ability to display detailed messages and warnings. Numerous parameters of the controller 42 may be configured by authorized personnel, but are not accessible to end users such as dump truck 10 operators. For example, both the first and second predetermined speeds may be permanently set, or they may be configurable. For security, various cryptographic techniques, such as, at a minimum, entering a password, may be required to access the configurability options. In some aspects, biometric identification, such as a fingerprint scan, may be required. In some aspects, the controller 42 configurations can only be changed by the dump truck 10 dealer or service technician. In other aspects, fleet managers may have the ability to configure the controllers 42 for all dump trucks 10 under their control.

Many commercially available tablet computers, in addition to touchscreen displays and satellite navigation receivers, include wireless communications, such as cellular network access. In aspects deploying such devices, parameters of the controllers 42 may be configured wirelessly by a dispatcher or other central management facility, using Over the Air (OTA) programming. As mentioned above, an alert by the TLL/TCA function when a dump truck 10 is driven at or above the selected predetermined speed without the tailgate 18 being securely latched and locked, may be wirelessly transmitted to a dispatcher or other central facility.

### Advantages

Aspects of the present disclosure present numerous advantages over the prior art. By automatically latching and locking the tailgate 18 whenever the dump truck 10 is in significant motion, the TLL process significantly improves road safety by making accidental releases of load during transit practically impossible. Furthermore, by verifying that the tailgate 18 is fully closed before actuating the latches 22, the TCA function prevents a common failure mode by ensuring that the latches 22 are not blocked and are operating properly to fully lock the tailgate 18. Spreading mode allows for spreading operation, by allowing the tailgate 18 to be open with the dump truck 10 in motion when required, but still provides protection for highway use by limiting the speed that triggers the TLL function. Furthermore, as an additional safety feature, spreading mode defaults to inactive at the end of each individual spreading run, and must be affirmatively selected by the dump truck 10 operator before the next spreading run.

The present disclosure may, of course, be carried out in other ways than those specifically set forth herein without departing from essential characteristics of the disclosure. The present aspects are to be considered in all respects as illustrative and not restrictive, and all changes coming within the meaning and equivalency range of the appended claims are intended to be embraced therein.

What is claimed is:

1. A method of securing a tailgate of a bed of a dump truck during transit, comprising:
sensing a speed of the dump truck;
sensing whether the tailgate is in a fully closed position;
comparing the sensed speed of the dump truck to a selected predetermined speed; and
when the sensed speed of the dump truck equals or exceeds the selected predetermined speed and the tailgate is in the fully closed position, automatically actuating one or more latches to lock the tailgate in the fully closed position.

2. The method of claim 1 further comprising actuating the one or more latches to release the tailgate from the closed position, in response to user input, only if the sensed speed of the dump truck is less than the selected predetermined speed.

3. The method of claim 2 further comprising, whenever the sensed speed of the dump truck equals or exceeds the selected predetermined speed and the one or more latches have been actuated to lock the tailgate in the fully closed position, disregarding any operator input to actuate the one or more latches to release the tailgate.

4. The method of claim 1 further comprising, when the sensed speed of the dump truck equals or exceeds the selected predetermined speed and the tailgate is not in the fully closed position, activating a visual and audible alarm.

5. The method of claim 4 wherein actuating a visual alarm includes displaying a message directing the dump truck operator to clear the one or more latches.

6. The method of claim 1 wherein sensing whether the tailgate is in a fully closed position comprises sensing an output of a proximity sensor mounted on a bed of the dump truck, which generates the output only when a target surface or mass mounted on the tailgate and aligned with the proximity sensor is withing a predetermined distance of the proximity sensor.

7. The method of claim 1 wherein the selected predetermined speed is a first predetermined speed applicable for dump truck operation other than spreading.

8. The method of claim 7 further comprising:
receiving a spreading mode input from an operator of the dump truck; and
in response to the spreading mode input, entering a spreading mode wherein the selected predetermined speed is a second predetermined speed, greater than the first predetermined speed, wherein the second predetermined speed is applicable for spreading material from the dump truck bed by partially raising a bed and driving the dump truck.

9. The method of claim 8 further comprising automatically exiting the spreading mode by selecting the first predetermined speed as the selected predetermined speed every time the sensed speed of the dump truck falls below the first predetermined speed.

10. A controller configured to control one or more tailgate latches of a dump truck, comprising:
memory; and
processing circuitry operatively connected to the memory, and configured to sense a speed of the dump truck;
sense whether the tailgate is in a fully closed position;
compare the sensed speed of the dump truck to a selected predetermined speed; and
when the sensed speed of the dump truck equals or exceeds the selected predetermined speed and the tailgate is in the fully closed position, automatically actuate the one or more latches to lock the tailgate in the fully closed position.

11. The controller of claim 10 wherein the processing circuitry is further configured to actuate the one or more latches to release the tailgate from the fully closed position, in response to user input, only if the sensed speed of the dump truck is less than the selected predetermined speed.

12. The controller of claim 11 wherein the processing circuitry is further configured to, whenever the sensed speed of the dump truck equals or exceeds the selected predetermined speed and the one or more latches have been actuated to lock the tailgate in the fully closed position, disregard any operator input to actuate the one or more latches to release the tailgate.

13. The controller of claim 10 wherein the processing circuitry is further configured to, when the sensed speed of the dump truck equals or exceeds the selected predetermined speed and the tailgate is not in the fully closed position, activate a visual and audible alarm.

14. The controller of claim 13 wherein the processing circuitry is configured to actuate a visual alarm by displaying a message directing the dump truck operator to clear the latch.

15. The controller of claim 10 wherein the processing circuitry is configured to sense whether the tailgate is in a fully closed position by sensing an output of a proximity sensor mounted on a bed of the dump truck, which generates the output only when a target surface or mass mounted on the tailgate and aligned with the proximity sensor is withing a predetermined distance of the proximity sensor.

16. The controller of claim 10 wherein the selected predetermined speed is a first predetermined speed applicable for dump truck operation other than spreading.

17. The controller of claim 16 wherein the processing circuitry is further configured to:
receive a spreading mode input from an operator of the dump truck; and
in response to the spreading mode input, enter a spreading mode wherein the selected predetermined speed is a second predetermined speed, greater than the first predetermined speed, wherein the second predetermined speed is applicable for spreading material from the dump truck bed by partially raising a bed and driving the dump truck.

18. The method of claim 17 wherein the processing circuitry is further configured to automatically exit the spreading mode by selecting the first predetermined speed as the selected predetermined speed every time the sensed speed of the dump truck falls below the first predetermined speed.

19. A dump truck, comprising:
a chassis;
a dump truck bed moveably connected to the chassis;
a dump truck bed actuating mechanism configured to raise and lower the dump truck bed;
a tailgate pivotally connected to the dump truck bed;
one or more latches configured to secure the tailgate to the dump truck bed in a closed position for holding material, and to allow the tailgate to at least partially separate from the dump truck bed in an open position for discharging material when the dump truck bed is raised by the dump truck bed actuating mechanism; and
a proximity sensor configured to output an indication when the tailgate is in a fully closed position on the dump truck bed.

20. The dump truck of claim 19 further comprising a controller is configured to:
sense a speed of the dump truck;
receive the indication that the tailgate is closed from the proximity sensor;
compare the sensed speed of the dump truck to a selected predetermined speed; and
when the sensed speed of the dump truck equals or exceeds the selected predetermined speed and the tailgate is in the fully closed position, automatically actuate the one or more latches to lock the tailgate in the closed position.
